(19) United States
(12) Patent Application Publication
(10) Pub. No.: US 2008/0181079 A1
(43) Pub. Date: Jul. 31, 2008

(54) DISK PROCESSING APPARATUS

(76) Inventor: Shu-Chi Hong, Taipei City (TW)

Correspondence Address: Joe McKinney Muncy, PO Box 1364, Fairfax, VA, 22038-1364, US

(21) Appl. No.: 11/699,467

(22) Filed: Jan. 30, 2007

(51) Int. Cl. G11B 15/18

(52) U.S. Cl. 369/72

(57) ABSTRACT

A disk processing apparatus used for cleaning, mending or damaging a disk includes a first arm and a second arm to define a clamping structure. The front end of the second arm is a detachable tongue plate, and the first arm and the tongue plate separately or individually have at least one processing unit. If the disk is placed in the disk processing apparatus and contacted with the processing unit, different materials and properties of a surface of the processing unit can clean, mend or damage the disk. If it is necessary to change the processing unit, the tongue plate of the second arm can be removed to facilitate the change of the processing unit.

### FIELD OF THE INVENTION

The present invention relates to a disk processing apparatus, and more particularly to a multifunctional disk processing apparatus.

### BACKGROUND OF THE INVENTION

A disk such as CD, VCD and DVD available in the market is generally used for storing a large quantity of data, and these disks usually come with a small size, an easy-to-carry feature and a low cost, and thus they are used extensively by corporations and individual users. From the bottom up, a disk is mainly divided into five layers: a substrate, a recording layer, a reflective layer, a protective layer and a label print. The substrate is provided primarily for supporting and protecting the disk; the recording layer is consisted of an organic dye for recording data; the reflective layer is provided for reflecting a laser of a reading device, such that the reading device can identify the data in the recording layer; the protective layer is another protecting structure used together with the substrate for preventing damages to the recording layer and the reflective layer; and the label print is provided for labeling the disk.

In the process of using a disk, the ways of processing the disk can be divided into a cleaning and repairing process, and a data damage process.

In general, the substrate and the protective layer are made of resin polymers to protect the data in the disk, but sometimes the recording layer or the reflective layer may be damaged by a user's careless accesses of the disk or a friction of an external object, and even a data loss may result. After a long time of use, the disk may be adhered with dusts or foreign substances, and the reading efficiency of the reading device will be affected, or the stored data will become unreadable. A conventional optical disk double-header cleaning device as disclosed in R.O.C. Patent Publication No. 450404 adopts a rocking handle at a circular top to drive an internal transmission body for its rotations, and the transmission body includes two cleaning fiber discs, such that when the transmission body rotates, the two cleaning fiber discs are rotated to clean the contact surface of the disk.

On the other hand, there is an issue of disclosing the data when the disk is not in use and discarded. To solve the problem, an optical disk signal destroyer disclosed in R.O.C. Patent No. M256563 adopts a scraper for destroying a directory area of the disk, so that the data stored in the disk cannot be read by the reading device.

A conventional clamp-type optical disc repairing device disclosed in U.S. patent application Ser. No. 11/450,302 (as illustrated in FIG. 1) uses a clamp-type disk method for cleaning, mending and damaging a disk, and such clamp-type optical disc repairing device includes a first arm 1 and a second arm 2 pivotally connected with each other, and the first arm 1 has a containing portion 3, and the second arm 2 has a positioning protrusion 4, and the containing portion 3 and the positioning protrusion 4 are connected with each other. The positioning protrusion 4 is provided for inserting a disk 6, and the first arm 1 and the second arm 2 separately have at least one contact pad 5. After the disk 6 is placed into the clamp-type optical disc repairing device, the two arms 1, 2 clamp the two contact pads 5 and touch both surfaces of the disk 6. If the contact pads are coated with mending liquid, then the disk 6 can be repaired. If the contact pads 5 are objects with a rough surface, then the disk 6 can be damaged. The contact pads 5 of the clamp-type optical disc repairing device can be changed according to different purposes of processing the disk 6. Since the clamp-type optical disc repairing device comes with a small size, a simple structure, and an easy-to-carry feature, it is portable and suitable for repairing or damaging a disk 6. However, the clamp-type optical disc repairing device provides a very limited space when the two arms 1, 2 are spread open, and it is not easy to change the contact pads 5, and thus reducing the convenience of carrying out different functions of processing the disk 6.

### SUMMARY OF THE INVENTION

Although the foregoing conventional clamp-type optical disk repairing device can clean or damage a disk by using different contact pads, the change of pads is inconvenient, and thus the present invention intends to improve the convenience of changing the contact objects of the disk. To achieve the foregoing objective, a disk processing apparatus of the present invention comprises a first arm and a second arm pivotally connected with each other, and an end of the second arm is a detachable tongue plate, and the tongue plate and the first arm separately or individually have at least one processing unit, and each of the tongue plate and first arm has a protrusion and a containing portion respectively, and the protrusion is provided to be inserted into the center hole of the disk, and the protrusion is connected to the containing portion. The disk processing apparatus can be in an open status or a latched status. The disk can be placed into the protrusion at an open status, and the protrusion is connected with the containing portion at the latched status to fix the disk in the disk processing apparatus, and the tongue plate and the processing unit of the first arm are in contact with the surfaces of the disk, such that the disk processing apparatus can be fixed, and the disk can be rotated for cleaning, mending or damaging the disk according to the material and property of the processing unit.

### BRIEF DESCRIPTION OF THE DRAWINGS

FIG. 1 is a perspective view of a conventional clamp-type disk repairing device;

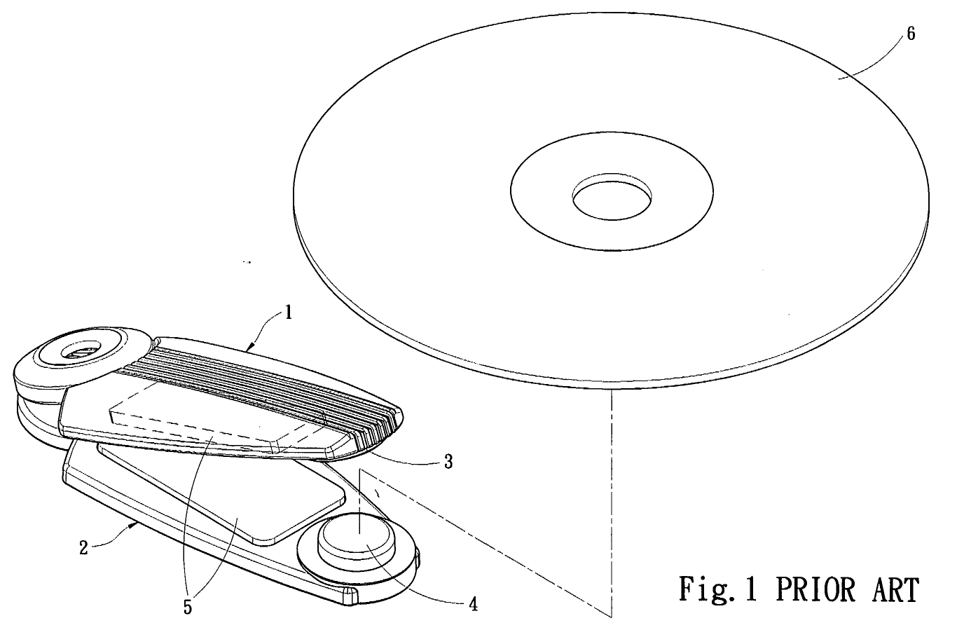

FIG. 2 is a perspective view of a disk processing apparatus of the present invention

FIG. 3 is an exploded view of a disk processing apparatus of the present invention;

FIG. 4A is a schematic view of a second arm of a disk processing apparatus of the present invention;

FIG. 4B is an exploded view of a second arm of a disk processing apparatus of the present invention;

FIG. 5A is a schematic view of installing a disk to a disk processing apparatus in accordance with the present invention; and

FIG. 5B is a schematic view of using a disk in a disk processing apparatus in accordance with the present invention.

### DETAILED DESCRIPTION OF THE PREFERRED EMBODIMENTS

The present invention will now be described in more detail hereinafter with reference to the accompanying drawings that show various embodiments of the invention.

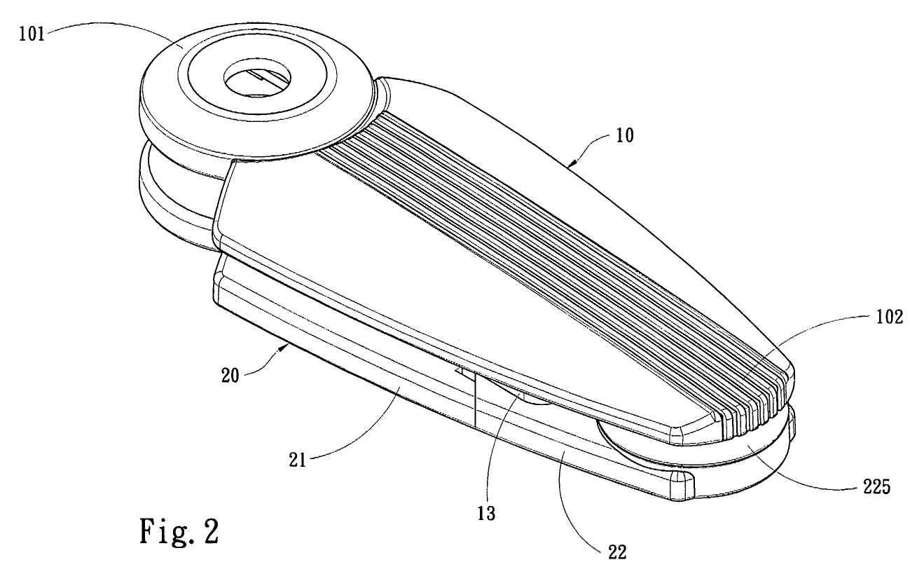

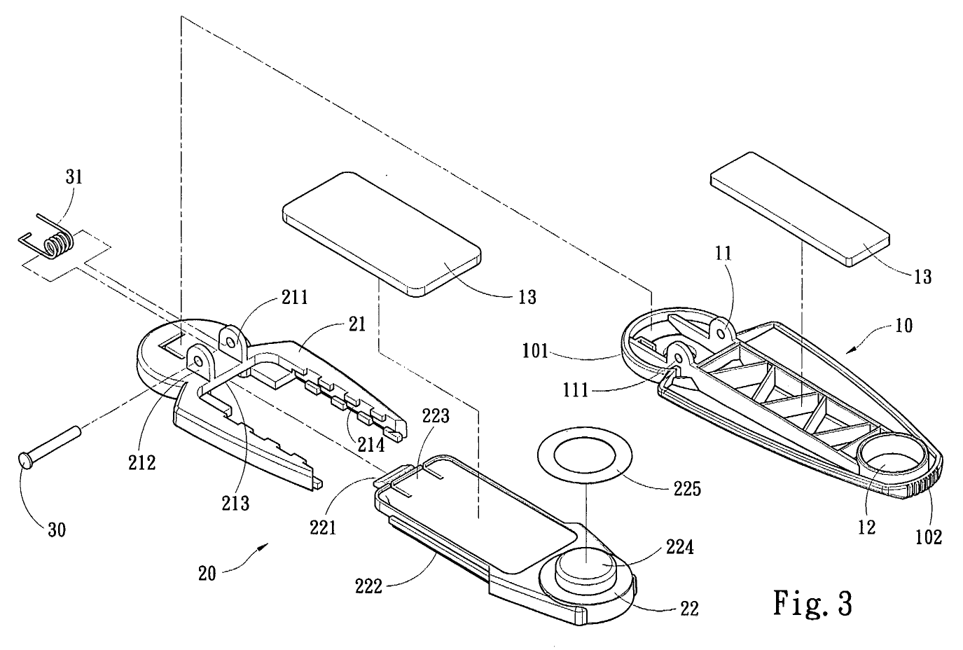

Referring to FIGS. 2 and 3 for a perspective view and an exploded view of a disk processing apparatus of the present invention, the invention comprises a first arm 10 and a second arm 20, and the second arm 20 comprises a base 21 and a detachable tongue plate 22, and the base 21 and the first arm 10 have a second pivoting portion 211 and a first pivoting portion 11 respectively, and each pivoting portion 11, 211 has two pivoting holes 111, 212 for inserting an insert bolt 30 into the pivoting holes 111, 212, such that the first arm 10 can be pivotally connected with the second arm 20. In addition, the insert bolt 30 is wrapped by a resilient element 31, and the resilient element 31 can be a spring.

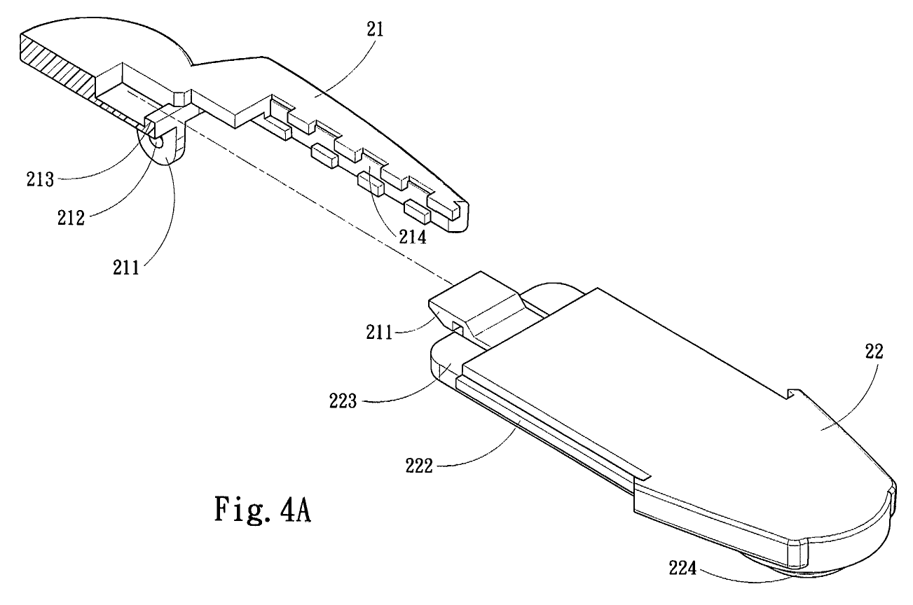

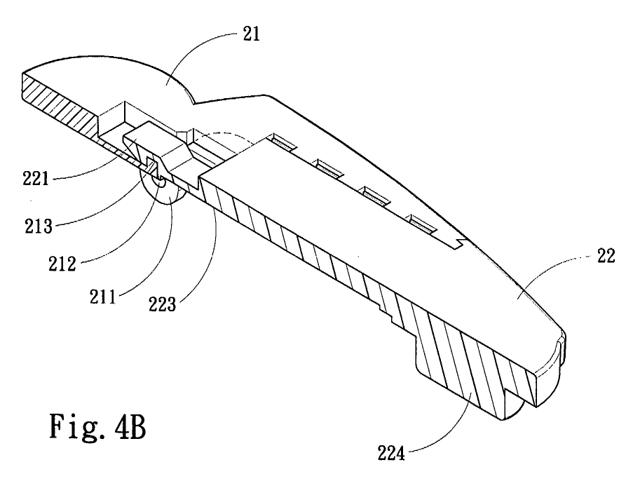

Referring to FIGS. 3, 4A and 4B for an exploded view of a disk processing apparatus, an exploded view and a perspective view of a second arm of a disk processing apparatus in accordance with the present invention respectively, a tongue plate 22 of the second arm 20 and the base 21 are detachable structures, and the tongue plate 22 includes a latching portion 221, an insert bar 222 and a separating press point 223, and the base 21 includes an engaging portion 213 and an insert groove 214, and the tongue plate 22 can be inserted into the insert groove 214 of the base 21 by the insert bar 222. If the tongue plate 22 is inserted all the way into the insert groove 214, the latching portion 221 and the engaging portion 213 can be used for connecting the base 21 and the tongue plate 22. On the other hand, if the base 21 and the tongue plate 22 are separated, then the separating press point 223 can be pressed to separate the latching portion 221 from the engaging portion 213, and then the tongue plate 22 can be pulled out along the insert groove 214.

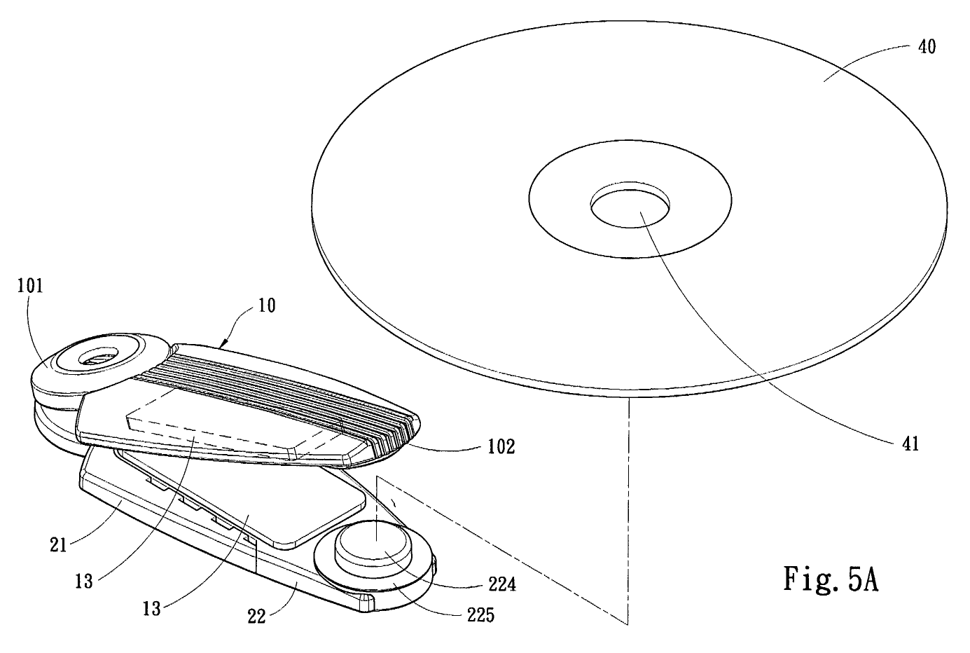

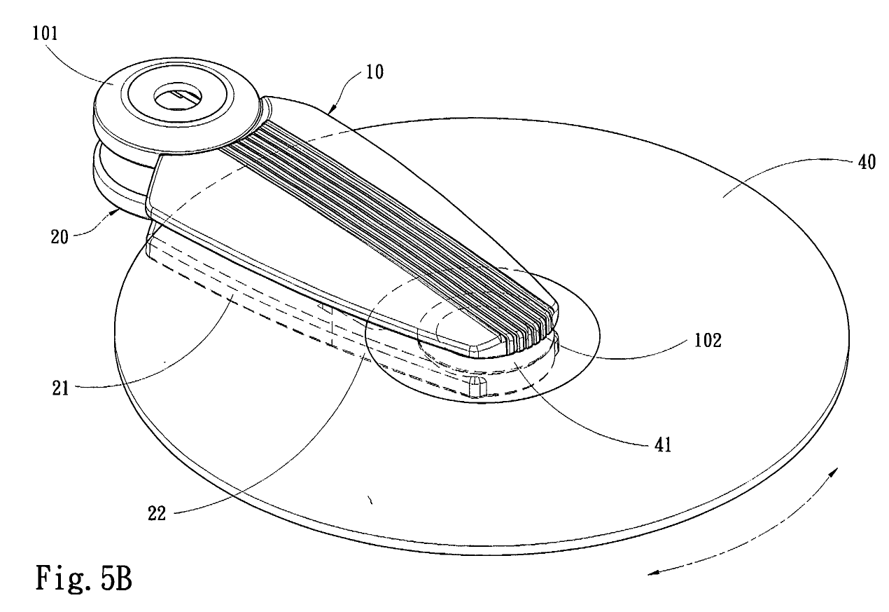

Referring to FIGS. 5A and 5B for schematic views of installing a disk to a disk processing apparatus and using a disk in a disk processing apparatus in accordance with the present invention respectively, a pivoting portion 211 is used for dividing the first arm 10 into a force applying end 101 and a clamping end 102. If a force is applied to the force applying end 101, the disk processing apparatus will be at an open status. If no force is applied to the force applying end 101, the disk processing apparatus will remain at a latched status. The tongue plate 22 of the second arm 20 has a protrusion 224, and the protrusion 224 has a washer 225 installed around the protrusion 224, and the protrusion 224 is provided to be inserted into a center hole 41 of the disk 40 for fixing the disk 40 to the disk processing apparatus, and the clamping end 102 of the first arm 10 has a containing portion 12 connectable with the protrusion 224 for assisting the fixture of the disk 40. The first arm 10 and the tongue plate 22 separately and individually have at least one processing unit 13, and the processing unit 13 can be made of different materials for different purposes. For instance, the processing unit 13 can be a flannelette for cleaning the disk 40, a mending liquid coated onto the disk for mending the disk 40, or an object with a rough surface such as sand paper for damaging the data of the disk 40. If the disk 40 is placed into the disk processing apparatus and situated at the latched status, the processing unit 13 will be in contact with both surfaces of the disk 40 for fixing the disk processing apparatus, rotating the disk 40, and performing the function of cleaning, mending or damaging the disk according to the material or property of the processing unit 13. Since the tongue plate 22 of the second arm 20 is a detachable object, therefore the tongue plate 22 can be removed first to provide a larger working space between the tongue plate 22 and the second arm 20 for changing the processing unit 13 more conveniently

In summation of the description above, the present invention herein enhances over the prior art and further complies with the patent application requirements, and thus is duly applied for the patent application.

While the invention has been described by means of specific embodiments, numerous modifications and variations could be made thereto by those skilled in the art without departing from the scope and spirit of the invention set forth in the claims.

1. A disk processing apparatus, for clamping a disk with a center hole to wipe, mend or damage said disk, comprising:
a first arm; and
a second arm, composed of a base and a tongue plate, and said tongue plate being insertable into said base, and said first arm and said base having a first pivoting portion and a second pivoting portion respectively, and said first pivoting portion and said second pivoting portion separately having a pivoting hole, and an insert bolt with a resilient element being passed through said pivoting hole for fixing said first arm and said second arm to define a clamping structure for containing a disk, and said first arm and said tongue plate individually or separately have at least one processing unit in contact with both surfaces of said disk.

2. The disk processing apparatus of claim 1, wherein said tongue plate has a protrusion, and said first arm has a containing portion coupled with said protrusion.

3. The disk processing apparatus of claim 2, wherein said protrusion can be inserted into a center hole of said disk.

4. The disk processing apparatus of claim 2, wherein said protrusion has a washer disposed around said protrusion.

5. The disk processing apparatus of claim 1, wherein said processing unit is a flannelette.

6. The disk processing apparatus of claim 1, wherein said processing unit is coated with a disk mending liquid.

7. The disk processing apparatus of claim 1, wherein said processing unit is an object having a rough surface.
